(19) United States
(12) Patent Application Publication
(10) Pub. No.: US 2022/0379922 A1
(43) Pub. Date: Dec. 1, 2022

(54) SYSTEM FOR MANEUVERING A VEHICLE

(71) Applicants: DENSO INTERNATIONAL AMERICA, INC., Southfield, MI (US); DENSO CORPORATION, Kariya (JP)

(72) Inventor: Daisuke TAKAMA, Southfield, MI (US)

(21) Appl. No.: 17/303,514

(22) Filed: Jun. 1, 2021

(51) Int. Cl. B60W 60/00; G05D 1/02; B60Q 9/00

(52) U.S. Cl. CPC B60W 60/0027; G05D 1/0212; B60Q 9/008; B60W 2554/801; B60W 2554/802; B60W 2554/4041; B60W 2552/53; B60W 2530/201; B60W 2554/4044; B60W 2554/4042; B60W 2554/4043

(57) ABSTRACT

A system for maneuvering a vehicle has a detection system, a prediction system, and a vehicle control system. The detection system is configured to detect a nearby vehicle adjacent to the vehicle. The prediction system is configured to calculate a predicted trajectory of the nearby vehicle upon receiving a detection result from the detection system. The vehicle control system is configured to maneuver the vehicle based on the predicted trajectory upon receiving a control signal from the prediction system. The vehicle control system maneuvers the vehicle to keep a specified distance away from the nearby vehicle. A method for maneuvering a vehicle includes detecting a nearby vehicle adjacent to the vehicle, calculating a predicted trajectory of the nearby vehicle, and maneuvering the vehicle based on the predicted trajectory to keep a specified distance away from the nearby vehicle.

### FIELD

The present disclosure relates to a system for maneuvering a vehicle. Specifically, the system maneuvers an autonomous vehicle for avoiding collisions with surrounding vehicles and/or objects.

### BACKGROUND

Driving assistant systems are required to maneuver an autonomous vehicle to avoid collisions with surrounding vehicles or objects. Such driving assistant systems need to maneuver the autonomous vehicle with high accuracy based on various traffic conditions and various types of surrounding vehicles or objects.

### SUMMARY

In an example, a system for maneuvering a vehicle is disclosed.

The system has a detection system, a prediction system, and a vehicle control system. The detection system is configured to detect a nearby vehicle adjacent to the vehicle. The prediction system is configured to calculate a predicted trajectory of the nearby vehicle upon receiving a detection result from the detection system. The vehicle control system is configured to maneuver the vehicle based on the predicted trajectory upon receiving a control signal from the prediction system. The vehicle control system maneuvers the vehicle to keep a specified distance away from the nearby vehicle.

In an example, a method for maneuvering a vehicle is disclosed.

The method includes detecting a nearby vehicle adjacent to the vehicle, calculating a predicted trajectory of the nearby vehicle, and maneuvering the vehicle based on the predicted trajectory to keep a specified distance away from the nearby vehicle.

Further areas of applicability of the present disclosure will become apparent from the detailed description, the claims and the drawings. The detailed description and specific examples are intended for purpose of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram illustrating a system for maneuvering an autonomous vehicle;

FIG. 2 is a flowchart showing an example of a maneuvering process;

FIG. 3 is a view showing an example of a situation where the maneuvering process is performed;

FIG. 4 is a diagram showing how a vehicle protrudes when making a turn;

FIG. 5 is a graph showing an example of how an estimated minimum distance between the autonomous vehicle and an adjacent vehicle changes as time elapses while making a turn parallel with each other;

FIG. 6 is a flowchart showing an example of a maneuvering process;

FIG. 7 is a flowchart showing an example of a maneuvering process;

FIG. 8A is a diagram showing predicted trajectories of the autonomous vehicle and the adjacent vehicle in a curve;

FIG. 8B is a diagram showing an example of a predicted trajectory of the adjacent vehicle and a corrective trajectory of the autonomous vehicle;

FIG. 9 is a flowchart showing an object determining process; and

FIG. 10 is a schematic diagram illustrating a system for maneuvering the autonomous vehicle.

In the drawings, reference numbers may be reused to identify similar and/or identical elements.

### DETAILED DESCRIPTION

The present disclosure relates to a system for maneuvering an autonomous vehicle (“ego vehicle”) based on predicted trajectories of nearby vehicles. The system can control the autonomous vehicle in a smooth manner to keep the proper distance between the autonomous vehicle and the nearby vehicles during a heavy traffic situation, especially during a turn at an intersection. In addition to using the trajectories of nearby vehicles, the system may also consider the presence of static objects, potholes, and/or faded/invisible road surface markings (i.e., lane markings).

Example embodiments will now be described with reference to the accompanying drawings.

A system 100 maneuvers an autonomous vehicle 10 (i.e., an ego vehicle) in a smooth manner based on predicted trajectories of nearby vehicles. The system 100 can control the autonomous vehicle 10 to keep a proper distance between the autonomous vehicle 10 and the nearby vehicles during a heavy traffic situation, especially during a turn at an intersection.

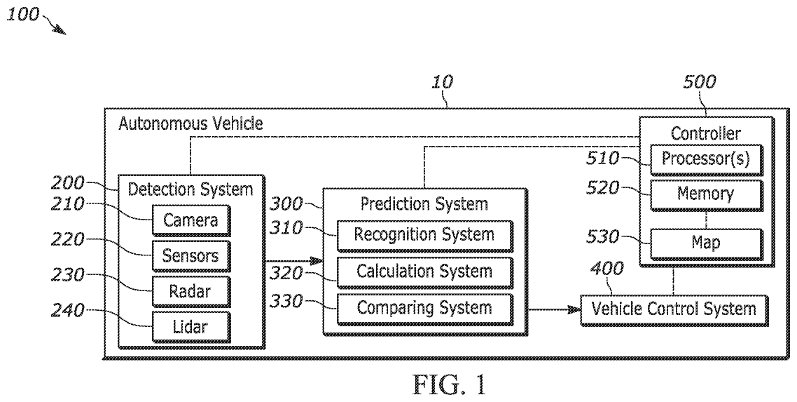

As shown in FIG. 1, the system 100 includes a detection system 200, a prediction system 300, and a vehicle control system 400.

The detection system 200 is configured to detect nearby vehicles and/or objects around the autonomous vehicle 10. The detection system 200 is also configured to detect road surface marking(s) such as lane marking(s) defining lanes or the center line of a road. The detection system 200 includes, for example, a camera 210, a plurality of sensors 220, a radar 230, and/or a Lidar 240. For example, the sensors 220 may include one or more sonars that detects a distance between the autonomous vehicle 10 and the nearby vehicles and/or a distance between the autonomous vehicle 10 and the objects. The sensors 220 may include other sensors such as a GPS sensor.

The prediction system 300, upon receiving detection results from the detection system 200, is configured to perform various prediction processes as described later. For example, the prediction system 300 includes a recognition system 310, a calculation system 320, and a comparing system 330. Each of the recognition system 310, the calculation system 320, and the comparing system 330 may be formed of one or more circuits in a controller 500. The controller 500 may be an electronic control unit (ECU) and performs the various prediction processes using one or more processors 510. The controller may include one or more memories 520 that store various data.

The vehicle control system 400, upon receiving prediction results from the prediction system 300, maneuvers the autonomous vehicle 10 to avoid any collision with the nearby vehicle(s) and/or nearby object(s). The vehicle controls system 400 may be formed of one or more circuits in the controller 500.

The controller 500 is configured to communicate with the detection system 200, the prediction system 300, and the vehicle control system 400. The controller 500 may be configured to perform various operations of the prediction system 300 and the vehicle controls system 400 based on detection results of the detection system 200. The one or more processors 510 may perform the various operations. The controller 500 includes one or more memories 520. For example, the memory 520 stores a map 530 therein.

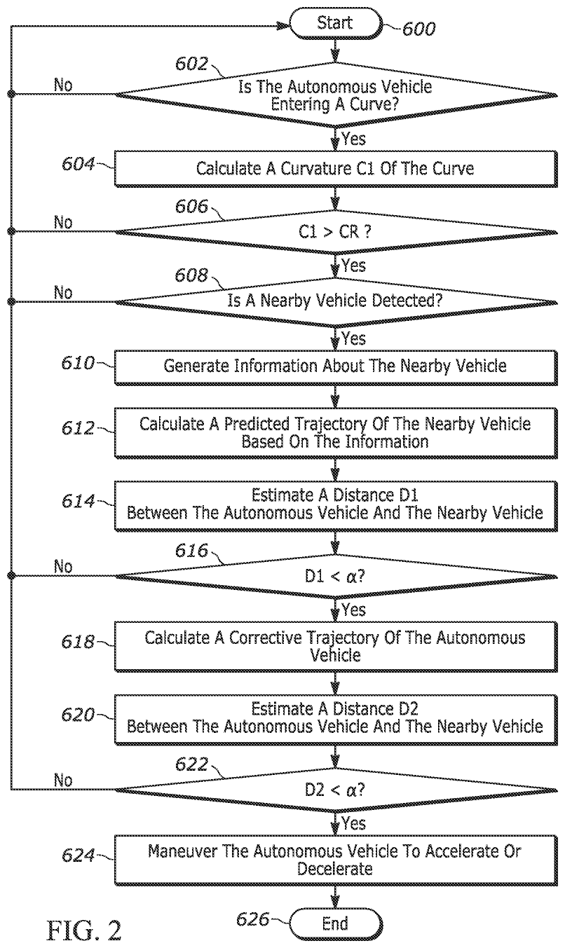

With reference to FIG. 2, one aspect of the system 100 will be described hereafter.

At 600, the system 100 starts a maneuvering process.

At 602, the recognition system 310 determines whether the autonomous vehicle 10 is entering a curve based on detection results from the detection system 200. For example, the detection results may be a view in front of the autonomous vehicle 10 captured by the camera 210. If the recognition system 310 determines that the autonomous vehicle 10 is not entering a curve, the process returns to 600. If the recognition system 310 determines that the autonomous vehicle 10 is entering a curve, the process proceeds to 604.

At 604, the calculation system 320 calculates a curvature C1 of the curve. For example, the calculation system 320 calculates the curvature C1 using the view captured by the camera 210, detection results from the sensors 220, and/or data (e.g., the map 530) stored in the memory 520.

At 606, the comparing system 330 compares the curvature C1 with a reference curvature CR. The reference curvature CR may be stored in the memory 520 in advance.

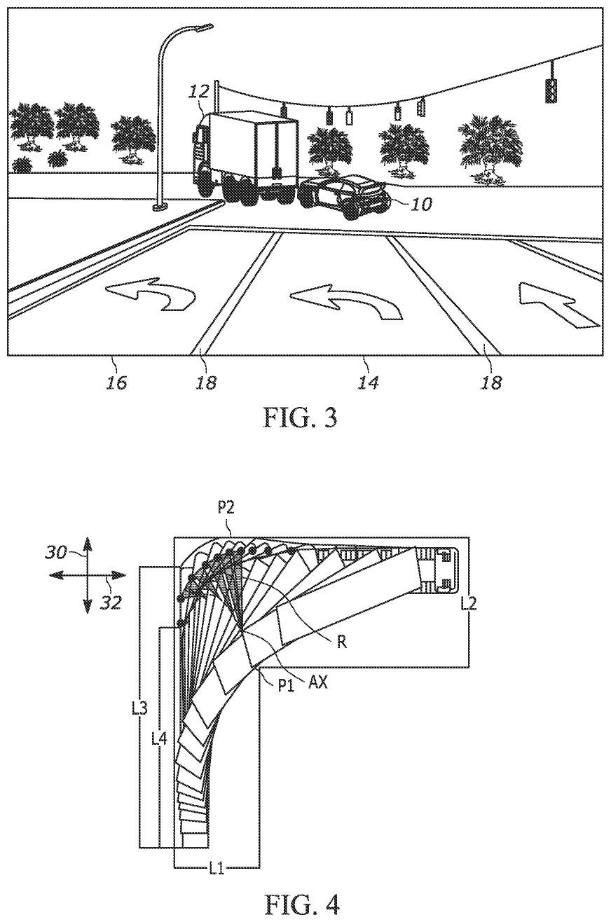

Here, as shown in FIG. 3, it is assumed that there are two lanes 14 and 16 for making a turn at an intersection and a nearby vehicle 12 is exist in the lane 16 on an inner side of the autonomous vehicle 10 in the lane 14. Because of the size and other factors of the nearby vehicle 12, a turning radius may be compromised that causes the nearby vehicle 12 to protrude into the lane 14 of the autonomous vehicle 10.

More specifically, FIG. 4 shows an example of how the nearby vehicle 12 protrudes into adjacent lane. According to this example, the nearby vehicle is a semi-truck pulling a trailer and takes a turn at a right angle. The right angle is defined by a first direction 30 along which the semi-truck travels before the turn and a second direction 32 along which the semi-truck travels after the turn. As shown in FIG. 4, the semi-truck, during the turn, shifts along the second direction 32 by a range L1. In addition, there is a certain range L2, along the first direction 30, between an inner-most position P1 and an outer-most position P2 of the semi-truck during the turn. Due to the range L1 and the range L2, the outer-most position P2 protrudes into the adjacent lane.

In FIG. 4, R represents a turning radius centering a turning center Ax. The turning radius R is not fixed and changes continuously during the turn. For example, the turning radius R is small at the beginning of the turn and increases as the steering wheel is turned. The continuous change of the turning radius R results in a shift of the turning center Ax as shown by a dashed line in FIG. 4. The turning radius R increases as size of the semi-track (e.g., an entire length L3 including the trailer and/or a length L4 of the trailer) becomes bigger. The increase of the turning radius R results in an increase of the range L1 and/or an increase of the range L2. As such, the reference curvature CR may be set on the assumption that the nearby vehicle 12 is a vehicle (e.g., a semi-track) which is big in size.

The increase of the turning radius R results in increasing the possibility of the protrusion of the nearby vehicle 12. The turning radius R increases as the curvature C1 increases. Thus, the reference curvature CR is set as a boundary for the determination of, for example, whether the nearby vehicle 12 protrudes into the lane 14.

If the curvature C1 is the reference curvature CR or smaller, it is considered that the nearby vehicle 12 will not protrude into the lane 14 of the autonomous vehicle 10. As such, the process returns to 600. Whereas, if the curvature C1 is larger than the reference curvature CR, it is considered that the nearby vehicle 12 will possibly protrude into the lane 14 of the autonomous vehicle 10. As such, the process advances to 608.

At 608, the recognition system 310 determines whether the nearby vehicle 12 is actually exist adjacent to the autonomous vehicle 10, e.g., in the lane 16. The recognition system 310 performs the determination, for example, based on the detection results from the detection system 200. If the recognition system 310 determines that there is no nearby vehicle, there is no need to maneuver the autonomous vehicle 10. As such, the process returns to 600. If the recognition system 310 determines that the nearby vehicle 12 is actually exist adjacent to the autonomous vehicle 10, i.e., in the lane 16, the process advances to 610.

At 610, the recognition system 310 generates information about the nearby vehicle 12 based on the detection results from the detection device 200. The recognition system 310 may be configured to determine a type of the nearby vehicle 12, e.g., whether the nearby vehicle 12 is a hatchback, sedan, SUV (sports utility vehicle), or a semi-truck pulling a trailer, based on the detection results of the detection device 200. The recognition system 310 may be configured to further determine a size (e.g., the length L3 and/or the length L4), offset, heading, and/or speed of the nearby vehicle 12.

Since a trajectory varies depending on size or other factors of the nearby vehicle 12 as described above, it is preferable to generate such information about the nearby vehicle 12 to calculate a predicted trajectory of the nearby vehicle 12 with high accuracy.

At 612, upon receiving the information, the calculation system 320 calculates a predicted trajectory of the nearby vehicle 12.

At 614, the calculation system 320 estimates a distance D1 between the autonomous vehicle 10 and the nearby vehicle 12 based on the predicted trajectory of the nearby vehicle 12. The calculation system 320 may be configured to refer the map 530 stored in the memory 520 to estimate the distance Dl.

At 616, the comparing system 330 compares the distance D1 with a reference distance α. The reference distance α is set as a minimum distance between the autonomous vehicle 10 and the nearby vehicle 12 which allows the autonomous vehicle 10 to avoid collision with the nearby vehicle 12. If the comparing system 330 determines that the distance D1 is the reference distance α or larger, it is considered that the autonomous vehicle 10 is distanced away enough from the nearby vehicle 12. As such, the process returns to 600. If the comparing system 330 determines that the distance D1 is shorter than the reference distance α, it is considered that a collision possibly occurs. As such, the process advances to 618.

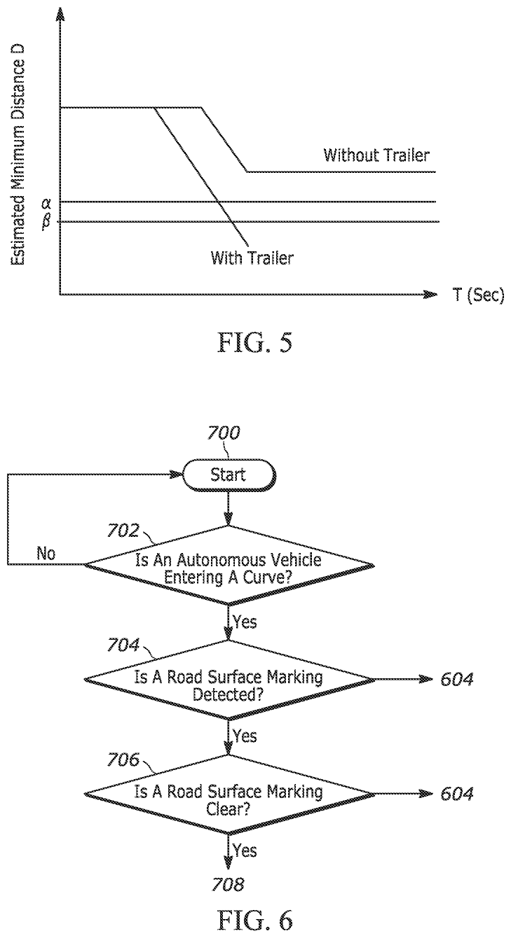

As shown in FIG. 5, the reference distance α is set considering an estimated minimum distance D [meter] between the autonomous vehicle 10 and the nearby vehicle 12. When the distance between the autonomous vehicle 10 and the nearby vehicle 12 is the estimated minimum distance D or shorter, it is considered that a collision between the autonomous vehicle 10 and the nearby vehicle 12 may occur possibly. The estimated minimum distance D shortens as a time T [second] elapses during the turn. In addition, the estimated minimum distance D shortens rapidly as the time T elapses when the nearby vehicle 12 has a trailer.

At 618, the calculation system 320 calculate a corrective trajectory of the autonomous vehicle 10 which is considered to be able to avoid a collision with the nearby vehicle 12. The corrective trajectory of the autonomous vehicle 10 is calculated to shift outward from an actual trajectory of the autonomous vehicle 10 to be away from the predicted trajectory of the nearby vehicle 12 calculated at 612.

At 620, the calculation system 320 estimates a distance D2 between the autonomous vehicle 10 and the nearby vehicle 12 based on the corrective trajectory of the autonomous vehicle 10 and the predicted trajectory of the nearby vehicle 12. The calculation system 320 may be configured to refer the map 530 to estimate the distance D2.

At 622, the comparing system 330 compares the distance D2 with the reference distance α. The reference distance α is the same criteria used at 616. If the comparing system 330 determines that the distance D2 is the reference distance α or larger, it is considered that the autonomous vehicle 10 is distanced away enough from the nearby vehicle 12. As such, the process returns to 600. If the comparing system 330 determines that the distance D2 is shorter than the reference distance α, it is considered that the nearby vehicle 12 will possibly come into contact with the autonomous vehicle 10. As such, the prediction system 300 transfers a control signal to the vehicle control system 400 and the process advances to 624.

At 624, upon receiving the control signal, the vehicle control system 400 maneuvers the autonomous vehicle 10 to keep a distance from the nearby vehicle 12. For example, the vehicle control system 400 may maneuver the autonomous vehicle 10 to accelerate or decelerate. As such, the vehicle control system 400 may accelerate the autonomous vehicle 10 to pass through a location, where the distance D2 becomes shorter than the reference distance α, before an estimated time to collision. Alternatively, the vehicle control system 400 may decelerate the autonomous vehicle 10 to keep traveling behind the the location or behind the nearby vehicle 12.

The maneuvering process ends at 626.

As described above, the system 100 considers the size of the nearby vehicle 12 (e.g., semi-truck) and other factors related to the nearby vehicle 12 to determine the predicted trajectory (or a lookahead trajectory) of the nearby vehicle 12. The predicted trajectory determined by the system 100 may indicate that the nearby vehicle 12 may protrude into the adjacent lane 14 of the autonomous vehicle 10. The system 10, by anticipating the protrusion by the nearby vehicle 12, can control the autonomous vehicle 10 appropriately to not only prevent a collision, but provide a smooth driving style which maximizes comfort to any occupants of the autonomous vehicle 10.

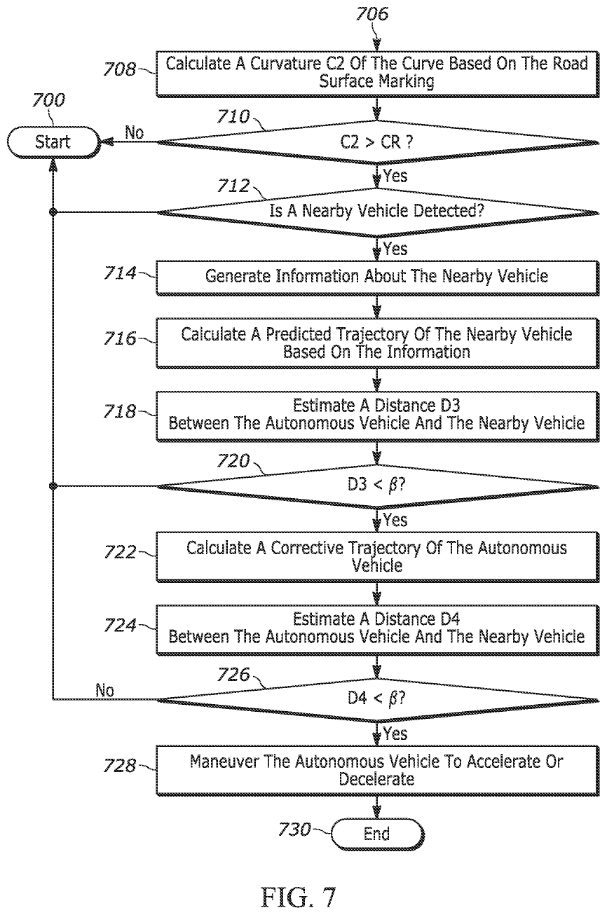

The system 100 described above may calculate a curvature of a curve based on road surface marking(s) 18 such as a lane marking. An example process using the road surface marking 18 such as lane markings will be described hereafter with reference to FIG. 6 and FIG. 7.

As shown in FIG. 6, the system 100 starts a maneuvering process at 700.

At 702, the recognition system 310, using detection results of the detection system 200, determines whether the autonomous vehicle 10 is entering a curve. If the recognition system 310 determines that the autonomous vehicle 10 is not entering a curve, the process returns to 700. If the recognition system 310 determines that the autonomous vehicle 10 is entering a curve, the process advances to 704.

At 704, the recognition system 310 determines whether the road surface marking 18 is detected. For example, the recognition system 310 may recognize the road surface marking 18 using a view captured by the camera 210 and/or the sensors 220. The recognition system 310 may be configured to refer data stored in the memory 520. If the recognition system 310 recognizes the road surface marking 18, the process advances to 706. If the recognition system 310 does not recognize the road surface marking 18, the process advances 604 so that the system 100 continues the maneuvering process without using the road surface marking 18.

At 706, the recognition system 310 determines whether the road surface marking 18 is clear enough to use in subsequent calculations. If the recognition system 310 determines that the road surface marking 18 is not clear, the process advances 604 so that the system 100 continues the maneuvering process without using the road surface marking 18. If the recognition system 310 determines that the road surface marking 18 is clear, the process advances to 708.

For example, if the recognition system 310 does not recognize the road surface marking 18 or determines that the road surface marking 18 is not clear enough, the calculation system 320, at 604, may calculate the curvature C1 based on the map 530.

The steps of 708 through 730 corresponds to the steps 604 through 626, respectively. As such, redundant explanations will be omitted.

At 708, the calculation system 320 calculates a curvature C2 of the curve based on the road surface marking 18, i.e., a lane marking. By calculating the curvature C2 using the road surface marking 18, the curvature C2 may be more accurate than the curvature C1 calculated without using the road surface marking 18. In other words, the calculation system 320 can calculate the curvature C2, with greater accuracy, using the road surface marking 18 as compared to the curvature C1 calculated using the map 540, only.

The predicted trajectory of the nearby vehicle 12 calculated at 716, a distance D3 between the autonomous vehicle 10 and the nearby vehicle 12 estimated at 718, a corrective trajectory of the autonomous vehicle 10 calculated at 722, and a distance D4 between the autonomous vehicle 10 and the nearby vehicle 12 calculated at 724 are based on the accurate curvature C2 ultimately. As such, the predicted trajectory, the distance D3, the corrective trajectory, and the distance D4 may be more accurate as compared to the predicted trajectory of 612, the distance D1 of 614, the corrective trajectory of 618, and the distance D2 of 620, respectively.

Because the distance D3 is more accurate than the distance D1, a reference distance β, which is a parameter used at 720 and 726, may be set shorter than the reference distance α (i.e., α>β). In other words, the reference distance β is set to include a smaller measurement error as compared to the reference distance α.

As such, when the corrective trajectory of the autonomous vehicle 722 is calculated at 722 to shift outward, a range of the shift can be smaller as compared to the range of the shift calculated at 618. Therefore, the system 100 can maneuver the autonomous vehicle 10 more smoothly and without interfering other vehicles.

In addition to using the trajectories of the nearby vehicle 12, the system 100 may also consider the presence of a static object 20 such as other vehicles and/or potholes. Such examples will be described hereafter.

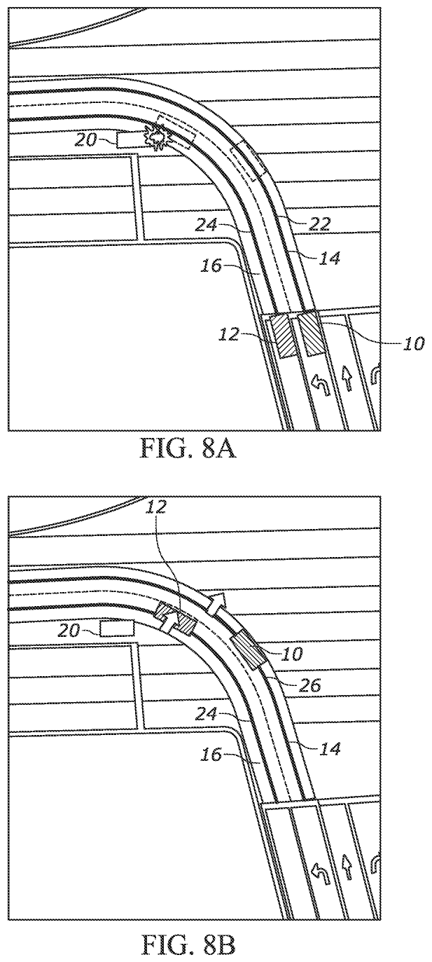

As shown in FIG. 8A, when the object 20 is present in the curve, e.g., on an inner side of the nearby vehicle 12, the object 20 may interfere a trajectory 24 of the nearby vehicle 12. In this situation, as shown in FIG. 8B, the nearby vehicle 12 may protrude toward the lane 14 of the autonomous vehicle 10 to avoid the object 20. The protruding trajectory 28 of the nearby vehicle 12 may interfere a trajectory 22 of the autonomous vehicle 10. As such, it is necessary to calculate a corrective trajectory 26 for the autonomous vehicle 10 to avoid a collision with the nearby vehicle 12.

Therefore, the system 100 may be configured to perform an object determination process before calculating the predicted trajectory of the nearby vehicle at 612 or 716.

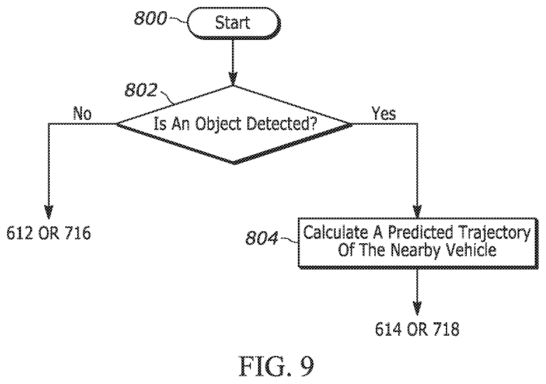

As shown in FIG. 9, the system 100 starts the object determination process at 800.

At 802, the recognition system 310 determines whether there is the object 20. For example, the recognition system 310 determines the object 20 based on detection results from the detection system 200. If the recognition system 310 determines there is no object, the process advances to 612 or 716 to calculate the predicted trajectory of the nearby vehicle 12 without considering an object. If the recognition system 310 determines that the object 20 is present, the process advances to 804.

At 804, the calculation system 320 calculates the predicted trajectory 28 of the nearby vehicle considering the object 20, and the process advances to 614 or 718 to estimate the distance between the autonomous vehicle 10 and the nearby vehicle 12.

The system 100 may perform the object determination process between 610 and 612 or between 714 and 716. Alternatively, the system 100 may perform the object determination process in parallel with the process from 600 through 610 or the process from 700 through 714.

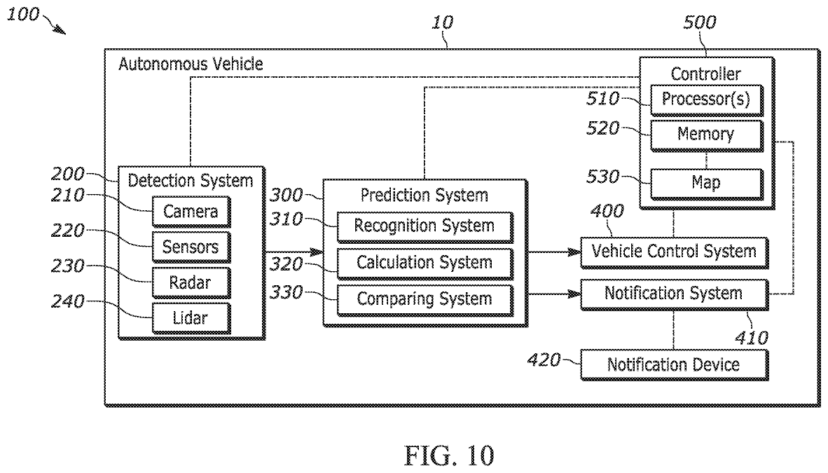

As shown in FIG. 10, the system 100 may further include a notification system 410. The notification system 410 may be formed of one or more circuits in the controller 510. The prediction system 300 may be configured to send a control signal to the notification system 410 when the system 100 maneuvers the autonomous vehicle 10 at 624 or 728 so that a user can recognize that the autonomous vehicle 10 is maneuvered to avoid a collision. For another example, the prediction system 300 may be configured to send a control signal to the notification system 410 when the distance between the autonomous vehicle 10 and the nearby vehicle 12 becomes to the reference distance α (or the reference distance β) or shorter at 616, 622, 720, or 726 so that a user can recognize that there is possibility of collision. For another example, the prediction system 300 may be configured to send a control signal to the notification system 410 when the the recognition system 320 recognizes the object 20 at 802 so that a user can recognize that there is possibility of collision.

The notification system 410, upon receiving the control signal, operates a notification device 420 to generate a notification (or an alarm) to make a user be aware of risks/possibility of collision. For example, the notification device 420 may be a display that shows the notification (e.g., an image or letters) on a screen. For example, the notification device 420 may be a speaker that generates sound for the notification.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system for maneuvering a vehicle, the system comprising:
a detection system that is configured to detect a nearby vehicle adjacent to the vehicle;
a prediction system that is configured to calculate a predicted trajectory of the nearby vehicle upon receiving a detection result from the detection system; and
a vehicle control system that is configured to maneuver the vehicle based on the predicted trajectory upon receiving a control signal from the prediction system, wherein
the vehicle control system maneuvers the vehicle to keep a specified distance away from the nearby vehicle.

2. The system for maneuvering a vehicle according to claim 1, wherein
the prediction system is configured to estimate a first distance between the vehicle and the nearby vehicle based on the predicted trajectory of the nearby vehicle, and
the vehicle control system maneuvers the vehicle when the first distance is shorter than a reference distance.

3. The system for maneuvering a vehicle according to claim 2, wherein the prediction system is configured to:
calculate a corrective trajectory of the vehicle when the first distance is shorter than the reference distance; and
estimate a second distance between the vehicle and the nearby vehicle based on the predicted trajectory of the nearby vehicle and the corrective trajectory of the vehicle, and
the vehicle control system maneuvers the vehicle when the second distance is shorter than the reference distance.

4. The system for maneuvering a vehicle according to claim 1, wherein the prediction system is configured to:
determine whether the vehicle is entering a curve;
calculate a curvature of the curve; and
calculate the predicted trajectory of the nearby vehicle based on the curvature.

5. The system for maneuvering a vehicle according to claim 4, wherein
the detection system is configured to detect the nearby vehicle that is present on an inner side of the vehicle in the curve, and
the prediction system is configured to calculate a corrective trajectory of the vehicle to shift outward in the curve and to be the specified distance away from the predicted trajectory of the nearby vehicle.

6. The system for maneuvering a vehicle according to claim 4, wherein the prediction system is configured to recognize a road surface marking and is configured to calculate the curvature using the road surface marking.

7. The system for maneuvering a vehicle according to claim 6, wherein the prediction system is configured to determine whether the road surface marking is clear and is configured to calculate the curvature using the road surface marking if the road surface marking is clear.

8. The system for maneuvering a vehicle according to claim 1, wherein
the prediction system is configured to generate information about the nearby vehicle based on the detection result from the detection system, and
the information includes a size, offset, heading, or speed of the nearby vehicle.

9. The system for maneuvering a vehicle according to claim 1, the system further comprising:
a notification system that is configured to generate a notification upon receiving a control signal from the prediction system, wherein
the notification notifies that there is possibility of collision between the vehicle and the nearby vehicle.

10. The system for maneuvering a vehicle according to claim 8, wherein the prediction system is configured to calculate the predicted trajectory of the nearby vehicle based on the information about the nearby vehicle.

11. A method for maneuvering a vehicle, the method comprising:
detecting a nearby vehicle adjacent to the vehicle;
calculating a predicted trajectory of the nearby vehicle; and
maneuvering the vehicle based on the predicted trajectory to keep a specified distance away from the nearby vehicle.

12. The method for maneuvering a vehicle according to claim 11, the method further comprising:
estimating a first distance between the vehicle and the nearby vehicle based on the predicted trajectory, wherein
the method maneuvers the vehicle when the first distance is shorter than a reference distance.

13. The method for maneuvering a vehicle according to claim 12, the method further comprising:
calculating a corrective trajectory of the vehicle when the first distance is shorter than the reference distance; and
estimating a second distance between the vehicle and the nearby vehicle based on the predicted trajectory of the nearby vehicle and the corrective trajectory of the vehicle, wherein
the method maneuvers the vehicle when the second distance is shorter than the reference distance.

14. The method for maneuvering a vehicle according to claim 11, the method further comprising:
determining whether the vehicle is entering a curve; and
calculating a curvature of the curve, wherein
the predicted trajectory of the nearby vehicle is calculated based on the curvature.

15. The method for maneuvering a vehicle according to claim 14, the method further comprising:
calculating a corrective trajectory of the vehicle; and
determining whether the nearby vehicle is present on an inner side of the vehicle in the curve, wherein
the corrective trajectory of the vehicle is calculated to shift outward in the curve and to be the specified distance away from the predicted trajectory of the nearby vehicle.

16. The method for maneuvering a vehicle according to claim 14, the method further comprising:
recognizing a road surface marking, wherein the curvature is calculated using the road surface marking.

17. The method for maneuvering a vehicle according to claim 16, the method further comprising:
determining whether the road surface marking is clear, wherein
the curvature is calculated using the road surface marking if the road surface marking is determined to be clear.

18. The method for maneuvering a vehicle according to claim 11, the method further comprising:
generating information about the nearby vehicle, wherein
the information includes a size, offset, heading, or speed of the nearby vehicle.

19. The method for maneuvering a vehicle according to claim 11, the method further comprising:
generating a notification that notifies there is possibility of collision between the vehicle and the nearby vehicle.

20. The method for maneuvering a vehicle according to claim 18, wherein the predicted trajectory of the nearby vehicle is calculated based on the information about the nearby vehicle.
